(19) United States
(12) Patent Application Publication
(10) Pub. No.: US 2015/0332040 A1
(43) Pub. Date: Nov. 19, 2015

(54) Systems, Devices, and Methods for Authenticating A Value Article

(71) Applicant: Honeywell International Inc., Morristown, NJ (US)

(72) Inventors: Chirag Patel, Bridgewater, NJ (US); Jack S. Croitor, Brooklyn, NY (US); Kirin T. Castelino, Mahwah, NJ (US)

(21) Appl. No.: 14/707,646

(22) Filed: May 8, 2015

Related U.S. Application Data
(60) Provisional application No. 62/000,213, filed on May 19, 2014.

(51) Int. Cl. G06F 21/44; G06F 21/50

(52) U.S. Cl. CPC G06F 21/44; G06F 21/50; G06F 2221/2129

(57) ABSTRACT

Systems, devices, and methods for authenticating a value article are provided herein. In an embodiment, a system for authenticating a value article that includes a luminescent material includes a portable computing device and an authentication device that is physically and electronically separate from the portable computing device. The portable computing device includes a microprocessor and a data receiver. The authentication device has the capacity to electronically connect with the portable computing device, and the authentication device includes an exciting light source, a photodetector, and a data transmitter. The exciting light source is provided to excite luminescent material of the value article, and the photodetector is provided to detect emitted radiation from the luminescent material after excitation. The data transmitter has the capacity to transfer a detected radiation signal or data derived therefrom from the authentication device to the data receiver of the portable computing device when electronically connected.

### PRIORITY CLAIMS

This application claims the benefit of U.S. Provisional Application No. 62/000,213, filed May 19, 2014.

### TECHNICAL FIELD

The technical field generally relates to systems, devices, and methods for authenticating a value article. More particularly, the invention relates to systems, devices, and methods for authenticating value articles using a portable computer for ready authentication of the value article.

### BACKGROUND

In many applications, it is necessary to distinguish an original article from a copy or counterfeit to validate the original article. An original article that includes an authenticating feature can be validated in many ways. Some methods involve visible (i.e., overt) authenticating features that are disposed on or incorporated into the article, such as a hologram on a credit card, an embossed image or watermark on a bank note, a security foil, a security ribbon, colored threads or colored fibers within a bank note, or a floating and/or sinking image on a passport. While these features are easy to detect with the eye and may not require equipment for authentication, these overt features are easily identified by a would-be forger and/or counterfeiter. As such, in addition to overt features, hidden (i.e. covert) features may be incorporated in original articles. Examples of covert features include invisible fluorescent fibers, chemically sensitive stains, and taggants such as luminescent pigments or fluorescent dyes that are incorporated into the substrate of the article.

While authentication of covert features that employ taggants is highly reliable through use of authentication equipment, the cost of equipment required for authentication is generally too high for and/or unavailable to the typical consumer or small business owner. Further, most authentication equipment is bulky and/or not easily portable, rendering use thereof inconvenient for many. Production of portable authentication equipment is challenging because the authentication equipment generally includes a significant amount of hardware, including an excitation source, a photodetector, a gain amplifier, an analog-to-digital converter, a microprocessor, and other components, and it is difficult to include all of those components in a sufficiently small package. To the extent that portable authentication equipment has been developed, output from such authentication equipment is generally limited to a pass/fail indication or a numerical value resulting from authentication testing due to limited processing capability (to conserve space) and lack of a user interface capable of conveying additional information.

Accordingly, it is desirable to provide portable systems, devices, and methods of authenticating value articles that are readily available to consumers and small business owners, and that provide extensive processing capability. Furthermore, other desirable features and characteristics of the present invention will become apparent from the subsequent detailed description of the invention and the appended claims, taken in conjunction with the accompanying drawings and this background of the invention.

### BRIEF SUMMARY

Systems, devices, and methods for authenticating a value article are provided herein. In an embodiment, a system for authenticating a value article that includes a luminescent material includes a portable computing device and an authentication device that is physically and electronically separate from the portable computing device. The portable computing device includes a microprocessor, a graphical user interface, and a data receiver. The authentication device has the capacity to electronically connect with the portable computing device, and the authentication device includes an exciting light source, a photodetector, and a data transmitter. The exciting light source is provided to excite luminescent material of the value article, and the photodetector is provided to detect emitted radiation from the luminescent material after excitation. The data transmitter has the capacity to transfer a detected radiation signal or data derived therefrom from the authentication device to the data receiver of the portable computing device when electronically connected.

In another embodiment, an authentication device includes an exciting light source, a photodetector, and a data transmitter. The exciting light source is provided to excite luminescent material of a value article, and the photodetector is provided to detect emitted radiation from the luminescent material after excitation. The data transmitter has the capacity to transfer a detected radiation signal or data derived therefrom from the authentication device to a data receiver of a portable computing device. The authentication apparatus is incapable of applying an authentication algorithm to authenticate a value article in the absence of the portable computing device.

In another embodiment, a method for authenticating a value article includes providing the value article that includes a luminescent material thereon. An exciting light source, a photodetector, and a portable computing device are provided. The portable computing device includes a microprocessor. The portable computing device is physically and electronically separate from the photodetector and the exciting light source, and the portable computing device is electronically connectable and disconnectable from the photodetector and the exciting light source. The photodetector and the portable computing device are electronically connected. The luminescent material on the value article is exposed to light produced by the exciting light source. Emitted radiation from the luminescent material is detected using the photodetector to produce a detected radiation signal. The detected radiation signal or data derived therefrom is transferred from the photodetector to the microprocessor after electronically connecting the photodetector and the portable computing device. An authentication algorithm is applied to the data derived from the detected radiation signal using the microprocessor.

### BRIEF DESCRIPTION OF THE DRAWINGS

The various embodiments will hereinafter be described in conjunction with the following drawing figures, wherein like numerals denote like elements, and wherein:

FIG. 1 is a perspective disassembled view of a portable computing device and an authentication device included in a system for authenticating a value article in accordance with an embodiment; and

FIG. 2 is functional block diagram of a system for authenticating a value article in accordance with an embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Systems, devices, and methods for authenticating a value article are provided herein. The systems include a portable computing device that includes a microprocessor and a data receiver, and the systems further include an authentication device that includes an exciting light source, a photodetector, and a data transmitter. The authentication device interrogates the value article by exciting luminescent material of the value article and detecting emitted radiation from the luminescent material after excitation using the photodetector to produce a detected radiation signal. The data transmitter of the authentication device has the capacity to transfer detected radiation signal or data derived therefrom to the data receiver of the portable computing device. As referred to herein, “detected radiation signal” includes an analog signal of measurements from the photodetector, and data derived from the signal refers to any data that result from modification (e.g., amplification, signal conversion from analog to digital, etc.) of the detected radiation signal. The microprocessor of the portable computer device applies an authentication algorithm to the detected radiation signal or data derived therefrom, among performing other functions, to authenticate the value article. The authentication device is physically and electronically separate from the portable computing device and is electronically connectable and disconnectable from the portable computing device, thereby enabling assembly of the system only under circumstances where authentication of a value article is desired. The portable computing device may be a smartphone, a tablet computer, a laptop computer, smartwatch, or any other electronic device that includes a microprocessor and that is typically carried on or with a person during normal usage. The authentication functions of the system are thus split between the portable computing device and the authentication device, with the authentication device interrogating the value article and providing a detected radiation signal or data derived therefrom to the portable computing device, and with the portable computing device conducting analysis of the data to determine authenticity. In this regard, the authentication device is free from a processor that actually analyzes the data for purposes of determining authenticity, thereby minimizing size, costs, and complexity of the authentication device. As such, for consumers or businesses that have a desire to authenticate value articles such as coins, banknotes, cards, or any other type of article that incorporates a luminescent material for security purposes, the authentication device can be readily obtained and used only when needed without being a permanent fixture of the portable computing device, thereby providing for ease of use and portability while also enabling processing capabilities of the portable computing device to be employed.

Value articles that include a luminescent material and that may be authenticated using the systems, devices, and methods described herein are not particularly limited and may include an identification card, a driver's license, a passport, identity papers, a banknote, a check, a document, a paper, a stock certificate, a packaging component, a credit card, a bank card, a label, a seal, a coin, a token, a casino chip, a medallion, or a postage stamp. The value articles generally include a substrate and the luminescent material may be included in a surface-applied or embedded authentication feature. Suitable luminescent materials are also not particularly limited provided that the luminescent materials are capable of producing a detectable emission (i.e., output radiation of relatively high spectral energy) in the infrared, visible, and/or ultraviolet portions of the electromagnetic spectrum upon excitation of the materials by appropriate external energy sources. When a luminescent material emits radiation, the emission occurs over a discrete span of time, which may be defined by a measurable decay time constant and signal intensity level. Materials typically described as “fluorophors” (or “fluorescent”) exhibit very short emission decay time constants in the micro-, nano- or pico-second range. Conversely, materials typically described as “phosphors” exhibit longer decay time constants ranging from several milliseconds to minutes or more (e.g., up to many hours). Fluorophors and phosphors are both suitable luminescent materials that may be employed in the value articles that are subject to authentication as described herein.

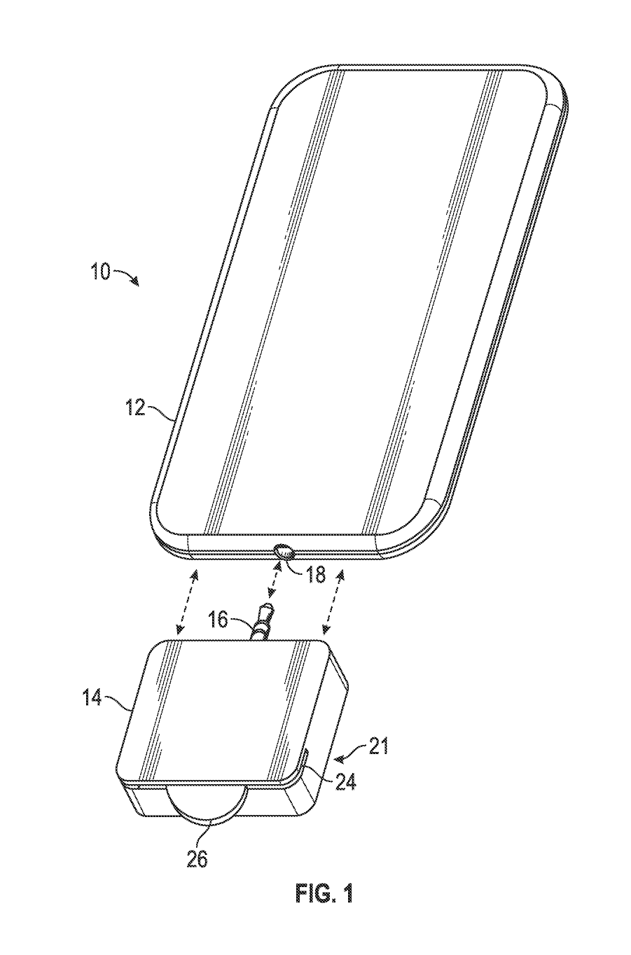

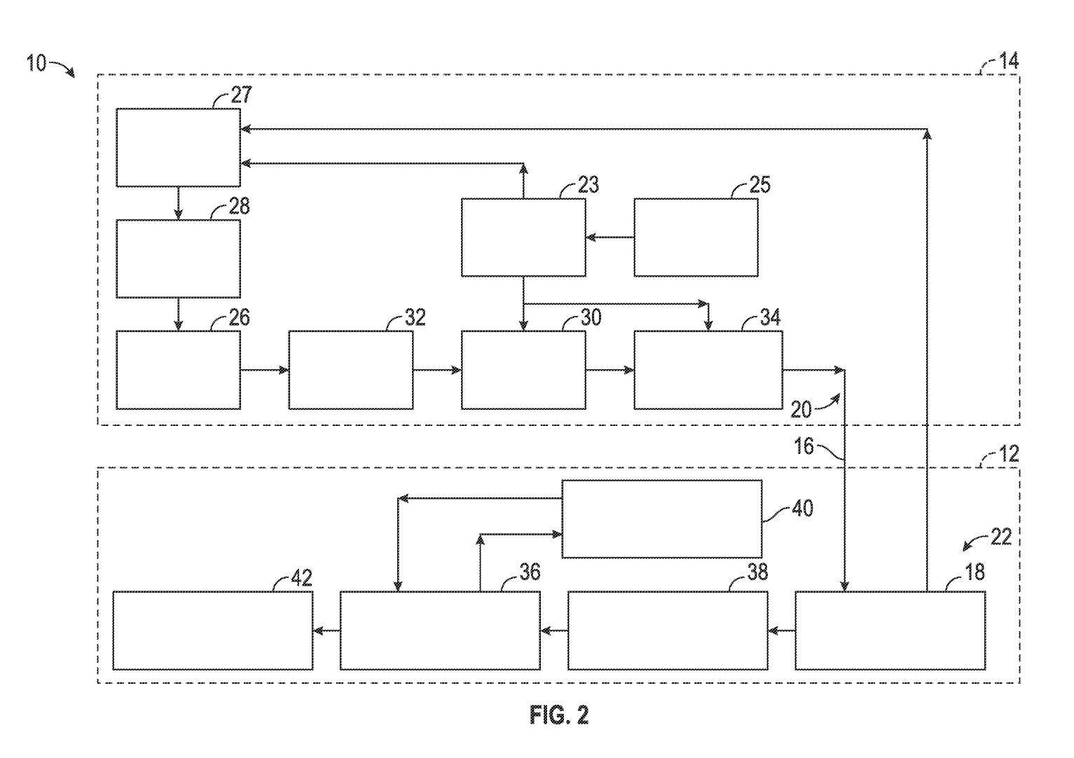

An exemplary embodiment of a system for authenticating a value article that includes a luminescent material will now be described with reference to FIGS. 1 and 2. Referring to FIG. 1, the system 10 includes a portable computing device 12 and an authentication device 14. The authentication device 14 is physically and electronically separate from the portable computing device 12. By “physically separate”, it is meant that the portable computing device 12 and the authentication device 14 are not permanently connected to each other, although after use the authentication device 14 may be physically connected to the portable computing device 12 in a manner that enables disconnection for authentication of a value article 26. For example, as shown in FIG. 1, the authentication device 14 may be physically connected to the portable computing device 12 by inserting a connector 16 such as a microphone jack 16 of the authentication device 14 into a port 18 such as a microphone port 18 of the portable computing device 12. While the microphone jack 16/microphone port 18 is useful for transfer of analog signals from the authentication device 14 to the portable computing device 12, as described in further detail below, it is to be appreciated that other forms of physical connection that support data transfer may be employed that support transfer of digital signals such as, but not limited to, a USB/USB port connection, a mini-USB/mini-USB port connection, an Apple® lightning® adaptor/lightning port connection, an Apple® 30-pin connector/dock connection, or the like. It is also to be appreciated that in other embodiments and although not shown, the authentication device 14 may be physically connected to the portable computing device 12 through a connection that does not support data transfer, e.g., in embodiments where wireless data transfer between the authentication device 14 and the portable computing device 12 may occur.

Referring again to FIG. 1, the authentication device 14 further includes an interrogation zone 21 that has the capacity to receive a portion of a value article 26 that includes the luminescent material. In an embodiment and as shown in FIG. 1, the interrogation zone 21 includes a slot 24 into which at least a portion of the value article 26 may be placed, and it is to be appreciated that the interrogation zone 21 may have the capacity to receive the entire value article 26 or only the portion thereof that includes the luminescent material. It is to be appreciated that the interrogation zone 21 may be configured in any way that allows interrogation of the luminescent material of the value article 26 by the authentication device 14, as described in further detail below, and the interrogation zone 21 may have a configuration different from that shown in FIG. 1. For example, in other embodiments and although not shown, the interrogation zone may include a scanning window that receives the portion of the value article 26 by passing the value article 26 past the scanning window.

Referring to FIG. 2, additional features of the authentication device 14 will now be described. As set forth above, the authentication device 14 primarily conducts interrogation of the value article 26 and generates data that is analyzed by the portable computing device 12 to determine authenticity of the value article 26. In this regard, the authentication device 14 includes components that enable interrogation of the value article 26 such as, but not limited to, an exciting light source 28 for exciting luminescent material of the value article 26 and a photodetector 30 for detecting emitted radiation from the luminescent material after excitation. It is to be appreciated that the authentication device 14 may include multiple exciting light sources 28 and multiple photodetectors 30, depending upon particular design and functionality considerations desired for the authentication device 14. The exciting light source 28 may include, for example, one or more low power laser diodes, LEDs, or other excitation sources. The photodetector 30 may include one or more electro-optical sensors, photodiodes, or other detection devices. The authentication device 14 may further include a power supply 23 that is in electrical communication with the exciting light source 28 and the photodetector 30. In embodiments, the power supply 23 is independent from a separate power supply (not shown) of the portable computing device 12. For example, the power supply 23 of the authentication device 14 may have the capacity to provide power from a replaceable or rechargeable battery 25 that is maintained in the authentication device 14. Further, the authentication device 14 may also include an excitation source driver 27 and a driver trigger receiver (not shown). The excitation source driver 27 may be an electric power circuit that is used to power (switch on/off) the exciting light source 28 and that may be controlled by a microprocessor 36 of the portable computing device 12 as described in further detail below. The light source trigger receiver receives control signals from the microprocessor 36 and provides the control signal to the excitation source driver 27.

The photodetector 30 has sensitivity within a spectral band of interest, and accordingly may detect emissions that are within that spectral band. For example, the photodetector 30 may include a silicon detector, an indium-gallium-arsenide (InGaAs) detector (e.g., a telecom type or extended InGaAs), a lead-sulfide detector, a lead-selenide detector, a germanium detector, an indium-antimonide detector, an indium-arsenide detector, a platinum-silicide detector, an indium-antimonide detector, or another type of detector. In embodiments, multiple photodetectors 30 may be used and configured to detect emissions within a channel corresponding to different bands of interest, and such photodetectors may be of the same or different type or class.

In an embodiment, an optical filter 32 may be positioned to filter the emissions from the luminescent material before they are provided to the photodetector 30, so that emissions only within an emission band (i.e., a subset of the entire spectrum) actually impinge upon an active area of the photodetector 30. It is to be appreciated that multiple optical filters 32 may be employed. The optical filter 32 may include, for example, one or more long pass, bandpass, or other types of filters that have the capacity to pass light only within a spectral band of interest, and to reject all other light.

The photodetector 30 produces the detected radiation signal, i.e., an electrical signal that is proportional to the intensity of emissions that impinge on an active area of the photodetector 30. More particularly, the detected radiation signal may be a signal (e.g., one or more analog intensity values) that is produced by the photodetector 30 and that represents an integrated intensity of the emissions received by the photodetector 30 along substantially all or a portion of the length of the value article 26 (e.g., between an incident and trailing edge of the article). The authentication device 14 may further include a gain amplifier 34 that is in electronic communication with the photodetector 30 for receiving the detected radiation signal and for increasing amplitude of the signal, thereby producing data derived from the detected radiation signal. The power supply 23 may also be in electrical communication with the gain amplifier 34.

As alluded to above, the authentication device 14 is also electronically separate from the portable computing device 12. The portable computing device 12 is electronically connectable to and disconnectable from the authentication device 14 and, in particular, the photodetector 30. To facilitate electronic connection and referring to FIG. 2, the authentication device 14 includes a data transmitter 20 that has the capacity to transfer the detected radiation signal or data derived therefrom from the authentication device 14, and the portable computing device 12 includes a data receiver 22 that has the capacity to receive the detected radiation signal or data derived therefrom from the data transmitter 20. As referred to herein, the data transmitter 20 includes one or more elements that convey detected radiation signal or data derived therefrom from the authentication device 14 to the data receiver 22. In embodiments, the data transmitter 20 and/or the data receiver 22 may be transceivers that have the capacity to both transmit and receive signals. In embodiments, the authentication device 14 and the portable computing device 12 are electronically connected through the physical connection, where the data transmitter 20 includes the connector 16 and the data receiver 22 includes the port 18 that has the capacity to receive the connector 16. In embodiments, the connector 16 is an analog connector such as a microphone jack and the data receiver 22 includes an analog input port 18 such as a microphone port that has the capacity to physically receive the analog connector 16. Alternatively, the authentication device 14 and the portable computing device 12 may be electronically connected through a wireless electronic connection (not shown), such as through a WiFi connection, a Bluetooth connection, or the like. In this embodiment, the data transmitter 20 may include a wireless antenna (not shown) for transmitting the detected radiation data.

In embodiments, the authentication device 14 has the capacity to transfer the detected radiation signal or data derived therefrom as an analog signal to the portable computing device 12. In particular, authentication is generally conducted on data derived from the detected radiation signal after conversion into a digital signal using an analog to digital converter. However, because an analog to digital converter is another component that may add size, complexity, and/or cost to the authentication device 14, and because the portable computing device 12 generally also includes an analog to digital converter 38, the signal transferred from the authentication device 14 may be in analog form.

Referring to FIG. 2 and as alluded to above, in addition to the data receiver 22, the portable computing device 12 may further include an analog to digital converter 38 for converting analog signals from the authentication device 14 to digital signals. However, it is to be appreciated that in other embodiments, the authentication device 14 may transfer the data derived from the detected radiation signal to the portable computing device 12 in a digital signal.

The portable computing device 12 also includes a microprocessor 36. The microprocessor 36 is a programmable integrated circuit that drives, synchronizes, and controls all electronic components of the portable computing device 12 and, for purposes herein, the authentication device 14. In this regard, the portable computing device 12 and, more particularly the microprocessor 36, may have the capacity to initiate transmissions of radiation from the exciting light source 28 of the authentication device 14, with either automatic initiation of transmissions upon connection of the authentication device 14 and the portable computing device 12 or controlled initiation of emissions in response to action taken by a user such as by entering a command in a graphical user interface 42 of the portable computing device 12 as described in further detail below. For example, the portable computing device 12 may include a trigger transmitter that may be separate from or part of the data receiver 22, with the trigger transmitter sending the control signal to the driver trigger receiver to initiate emissions from the exciting light source 28 using the excitation source driver 27. The trigger transmitter/driver trigger receiver configuration may provide further cost and size reduction to the authentication device 14 by delegating control signal generation to the portable computing device 12, and the trigger transmitter/driver trigger receiver configuration may be implemented in the embodiments where the data transmitter 20 includes the microphone jack 16 and the data receiver 22 includes the microphone port 18, with the control signal communicated through the microphone jack 16/microphone port 18 connection.

The portable computing device 12 may be programmed with an authentication algorithm 40, with the microprocessor 36 having the capacity to apply the authentication algorithm 40 to the data derived from the detected radiation signal. For example, in the embodiment shown in FIG. 2, the authentication algorithm 40 is applied to digital signals that are converted from the analog signals by the analog to digital converter 38 of the portable computing device 12. Conventional authentication algorithms may be applied to the digital signals to authenticate the value article 26 based upon various different parameters or combinations thereof. In embodiments, detected radiation signal may include information such as, but is not limited to, decay time constant and signal intensity level (optionally through the optical filter 32). Based upon results provided by applying the authentication algorithm 40, a comparison may be made to control values to render a determination on authenticity.

The authentication algorithm 40 may be part of a software application that is programmed into the portable computing device 12 (e.g., by downloading from a service provider), with the software application providing for various additional functions beyond providing the authentication algorithm 40. For example, the software application may have the capacity to initiate transmissions from the exciting light source 28 as described above. Additionally, the software application may have the capacity to provide control inputs to the photodetector 30, which cause the photodetector 30 to attempt to detect emissions emanating from the value article 26 in response to the luminescent material having absorbed (either directly or indirectly) at least some excitation energy from the exciting light source 28. Additionally, the software application may automatically initiate display of information in a graphical user interface 42 of the portable computing device 12 upon connection of the authentication device 14 thereto. Additionally, the software application may have the capacity to display settings for the authentication device 14 and authentication feedback on the graphical user interface 42 of the portable computing device 12. Additionally, the software application may have the capacity to transmit authentication feedback to a storage device (not shown) for archiving. In embodiments, the portable computing device 12 has the capacity to provide authentication feedback in the absence of a connection to a data network, since the software application may be downloaded onto the portable computing device 12 and then employed as a stand-alone authentication tool.

A method for authenticating a value article will now be described with reference to FIGS. 1 and 2. In accordance with an exemplary method and referring to FIG. 1, the value article 26 that includes the luminescent material thereon is provided in anticipation of conducting authentication of the value article 26. Referring to FIG. 2, the photodetector 30 and the portable computing device 12 are electronically connected. In an embodiment and referring to FIG. 1, the authentication device 14 is physically and electronically connected to the portable computing device 12 by inserting the connector 16 of the authentication device 14 into the port 18 of the portable computing device 12, thereby connecting the photodetector and the portable computing device 12. Referring again to FIG. 2, emission of light by the exciting light source 28 may be initiated after electronically connecting the photodetector 30 and the portable computing device 12, with the microprocessor 36 of the portable computing device 12 used to initiate emission of light by the exciting light source 28. Emission of light by the exciting light source 28 may occur automatically upon establishing electronic communication between the photodetector 30 and the portable computing device 12. Alternatively, a user may prompt initiating of light emission by the exciting light source 28 by executing a command on the portable computing device 12.

The luminescent material on the value article 26 is exposed to the light produced by the exciting light source to commence authentication. Referring to FIG. 1, the authentication device 14 may include the slot 24 and the value article 26 may be placed into the slot 24 to commence authentication. However, it is to be appreciated that different configurations of the authentication device 14 are possible provided the value article 26 can be exposed to the light from the exciting light source. Referring to FIG. 2, emitted radiation from the luminescent material is detected using the photodetector 30 to produce a detected radiation signal. In an embodiment, the photodetector 30 produces the detected radiation signal as an analog signal. The analog signal may be amplified by the gain amplifier 34 to produce an amplified analog signal including data derived from the detected radiation signal. The amplified analog signal may then be transferred to the portable computing device 12 through the connector 16 and port 18. In an embodiment, the amplified analog signal is converted to a digital signal using the analog to digital converter 38 in the portable computing device 12. The authentication algorithm 40 may then be applied to the digital signal using the microprocessor 36. Based upon the results produced by applying the authentication algorithm 40 to the digital signal, a determination of authenticity of the value article 26 may be made by comparison of the results to control values to render a determination on authenticity. The determination may be displayed on the graphical user interface 42 of the portable computing device 12 and/or archived. Additional options and data analysis may be possible using features of the portable computing device 12, as described above.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for authenticating a value article comprising a luminescent material, wherein the system comprises:
a portable computing device including a microprocessor, a graphical user interface, and a data receiver; and
an authentication device physically and electronically separate from the portable computing device, wherein the authentication device has the capacity to electronically connect with the portable computing device, and wherein the authentication device comprises:
an exciting light source for exciting the luminescent material of the value article;
a photodetector for detecting emitted radiation from the luminescent material after excitation; and
a data transmitter having the capacity to transfer a detected radiation signal or data derived therefrom from the authentication device to the data receiver of the portable computing device when electronically connected.

2. The system of claim 1, wherein the authentication device has the capacity to transfer the detected radiation signal as an analog signal to the portable computing device.

3. The system of claim 2, wherein the data transmitter comprises an analog connector.

4. The system of claim 3, wherein the data receiver comprises an analog input port having the capacity to physically receive the analog connector.

5. The system of claim 2, wherein the portable computing device further comprises an analog to digital converter for converting the analog signal from the authentication device to a digital signal.

6. The system of claim 1, wherein the portable computing device is programmed with an authentication algorithm and wherein the microprocessor has the capacity to apply the authentication algorithm to data derived from the detected radiation signal.

7. The system of claim 1, wherein the portable computing device has the capacity to provide authentication feedback in the absence of a connection to a data network.

8. The system of claim 1, wherein the portable computing device has the capacity to initiate transmissions from the exciting light source of the authentication device.

9. The system of claim 1, wherein the authentication device further comprises a gain amplifier in electronic communication with the photodetector for receiving the detected radiation signal or data derived therefrom.

10. The system of claim 1, wherein the authentication device further comprises a power supply in electrical communication with the exciting light source and the photodetector, wherein the power supply is independent from a separate power supply of the portable computing device.

11. The system of claim 1, wherein the authentication device further comprises an interrogation zone having the capacity to receive a portion of the value article that comprises the luminescent material.

12. The system of claim 1, wherein the authentication device is incapable of applying an authentication algorithm in the absence of the portable computing device.

13. An authentication device comprising:
an exciting light source for exciting luminescent material of a value article;
a photodetector for detecting emitted radiation from the luminescent material after excitation;
a data transmitter having the capacity to transfer a detected radiation signal or data derived therefrom from the authentication device to a data receiver of a portable computing device;
wherein the authentication device is incapable of applying an authentication algorithm to authenticate the value article in the absence of the portable computing device.

14. A method for authenticating a value article, wherein the method comprises the steps of:
providing the value article comprising a luminescent material thereon;
providing an exciting light source, a photodetector, and a portable computing device including a microprocessor, wherein the portable computing device is physically and electronically separate from the photodetector and the exciting light source and is electronically connectable and disconnectable from the photodetector and the exciting light source;
electronically connecting the photodetector and the portable computing device;
exposing the luminescent material on the value article to light produced by the exciting light source;
detecting emitted radiation from the luminescent material using the photodetector to produce a detected radiation signal;
transferring the detected radiation signal or data derived therefrom from the photodetector to the microprocessor after electronically connecting the photodetector and the portable computing device; and
applying an authentication algorithm to data derived from the detected radiation signal using the microprocessor.

15. The method of claim 14, wherein exposing the luminescent material to light produced by the exciting light source comprises initiating emission of light by the exciting light source after electronically connecting the photodetector and the portable computing device.

16. The method of claim 15, wherein initiating emission of light by the exciting light source comprises initiating emission of light by the exciting light source using the microprocessor.

17. The method of claim 15, wherein establishing electronic communication between the photodetector and the microprocessor automatically initiates emission of light by the exciting light source.

18. The method of claim 14, wherein detecting emitted radiation from the luminescent material using the photodetector produces the detected radiation signal as an analog signal.

19. The method of claim 18, further comprising converting the analog signal to a digital signal.

20. The method of claim 19, wherein an analog to digital converter is provided for converting the analog signal to the digital signal, wherein the analog to digital converter is physically and electronically separate from the photodetector, and wherein electronically connecting the photodetector and the portable computing device electrically connects the photodetector and the analog to digital converter.
